(19) United States
(12) Patent Application Publication
(10) Pub. No.: US 2007/0143613 A1
(43) Pub. Date: Jun. 21, 2007

(54) Prioritized network access for wireless access networks

(75) Inventors: Paul K. Sitch, Palo Alto, CA (US); Henry Haverinen, Jyvaskyla (FI); Joanna Jokinen, Espoo (FI); Michael G. Williams, Los Angeles, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/591,485

(22) Filed: Nov. 2, 2006

Related U.S. Application Data
(60) Provisional application No. 60/752,039, filed on Dec. 21, 2005.

(51) Int. Cl. H04L 9/00

(52) U.S. Cl. 713/171; 713/168

(57) ABSTRACT

The present invention relates to a method, terminal device, network element, authentication server, and computer-readable medium for controlling prioritized access to a wireless access network. An identifier portion in an authentication response is set to a service-specific unique default identifier portion, dedicated to a predetermined prioritized call, at a terminal device, when the predetermined prioritized call is activated. The authentication response is forwarded to a predetermined default authentication server where a predetermined default service-specific authentication method is initiated for authorizing the terminal device to access the predetermined prioritized service. Thereby, emergency calls or services are made by terminal devices without SIM or USIM, and no new authentication functionality related to prioritized calls is required due to the transparent character of the service-specific unique default identifier portion.

### REFERENCE TO RELATED APPLICATIONS

This application claims priority of U.S. Provisional Patent Application Ser. No. 60/752,039, filed Dec. 21, 2005. The subject matter of this earlier filed application is hereby incorporated by reference.

### BACKGROUND OF THE INVENTION

1. Field of the Invention

The present invention relates to a method and a system including a terminal device, a network element, an authentication server providing emergency access to a user in a wireless access network, in particular, the present invention relates to a system, a method, and a computer program embodied in a computer-readable medium for controlling prioritized access to a wireless access network.

2. Description of the Related Art

The growth of public Wireless Local Area Networks (WLANs) provides an opportunity for appropriately-equipped terminal devices or user equipments (UEs) in 3rd generation terminology to access cellular home networks and visited networks via such WLANs. WLANs providing such an interworking functionality are therefore referred to as an Interworking Wireless Local Area Network (I-WLANs). I-WLANs are connected to Private Land Mobile Networks (PLMNs) enabling UEs to access network services on Home Private Land Mobile Networks (HPLMNs) and Visited Private Land Mobile Networks (VPLMNs).

Wireless devices are bound by law to support emergency calls. Reporting of an emergency should be possible even when no session is currently active over a particular radio channel of a multi access device, for instance, the user is presently not attached to any radio, or a Subscriber Identity Module (SIM) or Universal Mobile Telecommunications System Subscriber Identity Module (USIM) is presently not inserted in the device.

Usually, emergency reports initiated by pulling a switch or calling an emergency number are generally treated in a prioritized manner, so that access is readily available to invoke an emergency alarm. However, wireless devices may not have reliable functions or be used reliably during an emergency, for instance, entering passwords or other authentication processes may not be done correctly. Moreover, the wireless device may be near a network or access network but not associated to that network.

I-WLAN access is defined in specifications 3rd Generation Partnership Project (3GPP) TS 23.234: 3rd Generation Partnership Project; Technical Specification Group Services and System Aspects; 3GPP system to Wireless Local Area Network (WLAN) interworking; System description (Release 7), 3GPP TS 24.234: 3rd Generation Partnership Project; Technical Specification Group Services and System Aspects; 3GPP system to Wireless Local Area Network (WLAN) interworking; User Equipment (UE) to network protocols; Stage 3 (Release 7), 3 GPP TS 29.234: 3rd Generation Partnership Project; Technical Specification Group Services and System Aspects; 3GPP system to Wireless Local Area Network (WLAN) interworking; Stage 3 (Release 7), and 3GPP TS 33.234: 3rd Generation Partnership Project; Technical Specification Group Services and System Aspects; 3G security; Wireless Local Area Network (WLAN) interworking security (Release 6).

3GPP wireless local area network (WLAN) interworking specifies several different interworking scenarios. Scenario 2 specifies, among other things, network access authentication based on the Extensible Authentication Protocol (EAP). Specifically, Scenario 2 specifies network discovery, network selection and Subscriber Identity Module (SIM) or Universal Mobile Telecommunications System Subscriber Identity Module (USIM) based network access authentication based on EAP-SIM and EAP-AKA (authentication and key agreement) protocols.

Network selection in 3GPP WLAN Scenario 2 includes two inter-related steps. The first is the selection of a WLAN radio network. The second is the selection of the preferred “first-hop” Public Land Mobile Network (PLMN), if several PLMNs are available via the radio network. In one network selection procedure, the UE may need to go through all available radio networks in order to determine whether the home PLMN is available via some of the radio networks. Only after enumerating the available WLAN radio networks and the connected PLMNs, is the terminal able to select the radio network to join and the PLMN to use. Scenario 3 in 3GPP provides access to packet switching (PS) service via a serving GSN (GPRS Support Node).

For direct IP access (Scenario 2) and 3GPP IP access (Scenario 3), an Extensible Authentication Protocol (EAP) SIM/AKA (Authentication and Key Agreement) procedure is used for authentication, where authorization is done based on a subscriber check against information held at a subscriber database, such as a Home Subscriber Server (HSS).

However, currently, no mechanism exists to indicate to a WLAN access network or to a 3GPP AAA Server or to Scenario 3 of I-WLAN access that access is needed for an emergency call or another prioritized call. Thus, no mechanism is provided to the user to indicate that an emergency request should receive special treatment or that the user is to be given special treatment.

In another 3GPP system, a Voice over Internet Protocol (VoIP) emergency call support is described, where VoIP emergency calls are supported via a WLAN by using a pseudo IMSI (International Mobile Subscriber Identity) to facilitate WLAN access. The pseudo IMSI is used to create a user-specific pseudo network access identifier (NAI) to be used for initial access and the authentication procedure. The pseudo IMSI is made up of a unique combination of mobile country code (MCC) and mobile network code (MNC) and digits from the International Mobile Equipment Identity (IMEI). However, such user-specific access scheme requires intensive signaling and adaptation of involved network elements. Accordingly, a system and method are needed in which authorization is not needed before an emergency alarm is sounded or contact is made to an emergency center in order to expedite an emergency call.

### SUMMARY OF THE INVENTION

In accordance with an embodiment of the present invention, there is provided a method of controlling prioritized access to a wireless access network. The method includes setting an identifier portion of an authentication response to a service-specific unique default identifier portion, wherein the service-specific unique default identifier portion defines an activation of a call for a predetermined prioritized service at a terminal device, transmitting the authentication response to the wireless access network, detecting the default identifier portion at the wireless access network, and forwarding the authentication response to a predetermined default authentication server in response to the detection of the default identifier portion at the wireless access network. The method further includes initiating at the default authentication server a default service-specific authentication method for authorizing the terminal device to access the predetermined prioritized service.

In accordance with an embodiment of the present invention, there is provided a terminal device for providing prioritized access to a wireless access network. The terminal device includes setting means for setting an identifier portion of an authentication response to a service-specific unique default identifier portion, wherein the service-specific unique default identifier portion defines an activation for a predetermined prioritized service.

In accordance with an embodiment of the present invention, there is provided a network element of a wireless access network for controlling prioritized access to the wireless access network. The network element includes detecting means for detecting a predetermined unique default identifier portion in a received authentication response. The network element also includes forwarding means for transmitting the received authentication response to a predetermined default authentication server in response to the detection of the unique default identifier portion by the detecting means.

In accordance with an embodiment of the present invention, there is provided an authentication server for controlling prioritized access to a wireless access network. The authentication server includes means for detecting a predetermined unique default identifier portion in a forwarded authentication response received from the wireless access network, and initiating means for initiating a predetermined authentication method dedicated to the unique default identifier portion in response to the detection of the unique default identifier portion by the detecting means.

In accordance with an embodiment of the present invention, there is provided a computer program embodied on a computer readable medium. The computer program is configured to perform a control of prioritized access to a wireless access network. The computer program is configured to perform setting an identifier portion of an authentication response to a service-specific unique default identifier portion, wherein the service-specific unique default identifier portion defines an activation of a call for a predetermined prioritized service at a terminal device.

In accordance with an embodiment of the present invention, there is provided a computer program embodied on a computer readable medium. The computer program is configured to perform a control of prioritized access to a wireless access network. The computer program is configured to perform transmitting an authentication response to the wireless access network, detecting the default identifier portion at the wireless access network, and forwarding the authentication response to a predetermined default authentication server in response to the detection of the default identifier portion at the wireless access network.

In accordance with an embodiment of the present invention, there is provided a computer program embodied on a computer readable medium. The computer program is configured to perform a control of prioritized access to a wireless access network. The computer program configured to perform initiating at a default authentication server a default service-specific authentication method for authorizing a terminal device to access a predetermined prioritized service.

In accordance with an embodiment of the present invention, there is provided a smart card including a computer program, the computer program being configured to perform a control of prioritized access to a wireless access network. The computer program configured to perform transmitting an authentication response to the wireless access network, detecting the default identifier portion at the wireless access network, and forwarding the authentication response to a predetermined default authentication server in response to the detection of the default identifier portion at the wireless access network.

In accordance with an embodiment of the present invention, there is provided a system for controlling prioritized access to a wireless access network. The system includes a terminal device setting an identifier portion of an authentication response to a service-specific unique default identifier portion, wherein the service-specific unique default identifier portion defines an activation for a predetermined prioritized service.

In accordance with an embodiment of the present invention, there is provided a system for controlling prioritized access to a wireless access network. The system includes a network element of a wireless access network including detecting means for detecting a predetermined unique default identifier portion in a received authentication response, and forwarding means for transmitting the received authentication response to a predetermined default authentication server in response to the detection of the unique default identifier portion by the detecting means.

In accordance with an embodiment of the present invention, there is provided a system for controlling prioritized access to a wireless access network. The system includes an authentication server including means for detecting a predetermined unique default identifier portion in a forwarded authentication response received from the wireless access network, and initiating means for initiating a predetermined authentication method dedicated to the unique default identifier portion in response to the detection of the unique default identifier portion by the detecting means.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a schematic diagram of a network architecture, in accordance with an embodiment of the present invention;

FIG. 2 illustrates a schematic signaling and processing diagram of an access control operation, in accordance with an embodiment of the present invention; and

FIG. 3 illustrates schematic block diagrams of a terminal device and network devices, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. The embodiments of the present invention described below provide a system, a method, and a computer program embodied in a computer-readable medium for controlling prioritized access to a wireless access network. When an emergency call or prioritized call is activated from a terminal devise or user equipment, at the terminal device, an identifier portion of an authentication message/response is set to a service-specific unique default identifier portion, where the service-specific unique default identifier portion is dedicated to define an occurrence or activation of the emergency call. Then, the authentication response is forwarded to a predetermined default authentication server where a predetermined default service-specific authentication method is initiated for authorizing the terminal device to access predetermined prioritized service through the wireless access network. Thereby, emergency calls can be made by terminal devices without Subscriber Identity Module (SIM) or Telecommunications System Subscriber Identity Module (USIM) and no new authentication functionality related to prioritized calls is required due to a transparent character of the service-specific unique default identifier portion.

In accordance with an exemplary embodiment, the present invention will be described based on I-WLAN network architecture as defined in 3rd Generation Partnership Project; Technical Specification Group Services and System Aspects; Requirements on 3GPP system to Wireless Local Area Network (WLAN) interworking (Release 7), incorporated herein by reference.

In a network architecture, before allowing the terminal device to access a wireless network and associated resources, the terminal device is authenticated using a general authentication mechanism or access control mechanism. Once the terminal device is authenticated, the terminal device is allowed or authorized to access the wireless network within preset wireless access conditions based on the identity of the terminal device. For instance, a common authentication mechanism or access control is binary, which either allows access or denies access to the terminal device based on membership in a group. The authentication mechanism or access control is based on a three-party model, which involves a supplicant (i.e., the terminal device) which requires access, an authenticator which grants access, and an authentication server which gives permission. The supplicant has an identity and credentials to prove that it is true what it claims to be. The supplicant is connected to a network through an authenticator's port that is access controlled.

The authenticator does not know whether the supplicant can be allowed access. Rather, the authentication server determines whether the supplicant can be allowed access. The supplicant initiates an access request, and the authenticator starts a message exchange based on an authentication protocol such as an Extensible Authentication Protocol (EAP). At some point, the authenticator communicates with the authentication server and a set of exchanges then occurs between the supplicant, the authenticator, and the authentication server. At the end of these exchanges, a success state or failure state is reached. If the authentication succeeds, the authenticator allows network access to the supplicant through the authenticator's port. The authenticator also keeps a security context of the supplicant and the authenticator's port.

The access media can be any medium selected from Ethernet, Token Ring, WLAN, or the original media in a serial Point-to-Point protocol (PPP) link. EAP specifications provide a framework for exchanging authentication information after a link layer between the terminal device and the network has been established. Although the exchange of the authentication information between the terminal device and the authenticator does not need IP, such exchange is a function of a transport protocol layer to specify how EAP messages can be exchanged over the access network. The actual authentication mechanism or process is the one that defines how and what credentials should be exchanged between the supplicant and the authenticator.

In accordance with an exemplary embodiment of the present invention, access by the supplicant of the network resources is to be performed via a WLAN using EAP, which is a flexible protocol used to carry arbitrary authentication information and which is defined in the IETF (Internet Engineering Task Force) specification RFC 2284.

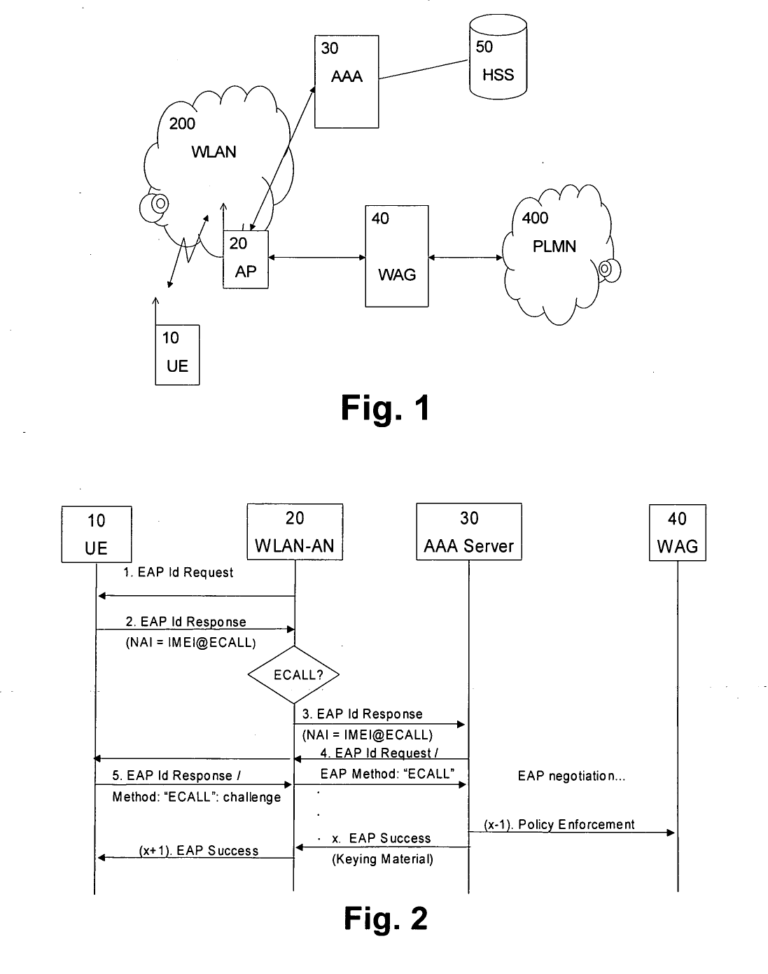

FIG. 1 shows a schematic block diagram of network elements in a network architecture, in which a terminal device, mobile equipment, or user equipment (UE) 10 is connected via an air interface to an access point (AP) 20 of a WLAN 200, in accordance with an embodiment of the present invention. Authentication and authorization is controlled by an Authentication, Authorization and Accounting server (AAA) 30 based on information obtained from a subscriber database, such as a Home Subscriber Server (HSS) 50. In one embodiment, the UE 10 (i.e., the supplicant), the AAA server 30 (i.e., the authenticator) and the HSS5 50 (i.e., the authentication server) form the three-party model previously described performing the authentication mechanism and process.

After authorization and authentication, the UE 10 operatively connects via the WLAN 200, which serves as an interworking network, to a WLAN access gateway (WAG) 40 providing access to a Public Land Mobile Network (PLMN) 400 (via a Packet Data Gateway (PDG)) from where the UE 10 has access to external networks, such as an IP based network or an IP multimedia subsystem (IMS).

In the architecture of FIG. 1, an EAP authentication procedure may be initiated in a WLAN-specific way, in accordance with an alternative embodiment of the present invention. All EAP packets would be transported over the WLAN interface encapsulated within a WLAN technology specific protocol. A number of EAP requests and EAP response message exchanges are executed between the AAA server 30 and the UE 10. The amount of round trips depends, for instance, on the utilized EAP type. Information stored in and retrieved from the HSS 50 may be needed to execute a certain number of EAP message exchanges. Information to execute the authentication with the UE 10 is also retrieved from the HSS 50. In one embodiment, the information retrieval from the HSS 50 may be needed only if necessary information to execute the EAP authentication is not already available in the AAA server 30. In another embodiment, the information retrieval from the HSS 50 may be done at all times.

In general, a user name part of the provided user-specific pseudo network access identifier (NAI) identity is utilized to identify the UE 10. During information retrieval, the HSS 50 checks whether another AAA server is already registered to provide services to the UE 10. In case the HSS 50 detects such another AAA server, the HSS 50 provides the current AAA server 30 with the previously registered AAA server address. The authentication signaling is then routed to the previously registered AAA server. The subscriber's WLAN related profile is retrieved from the HSS 50. If the EAP authentication and authorization was successful, the AAA server 30 sends an access accept message to the WLAN 200. In the access accept message, the AAA server 30 includes an EAP success message, keying material derived from the EAP authentication, and connection authorization information to the WLAN 200. The WLAN 200 stores the keying material and authorization information to be used in communication with the authenticated UE 10. Then, the WLAN 200 informs the UE 10 about the successful authentication and authorization with an EAP success message.

For a specific I-WLAN emergency call case, during a Scenario 2 “attach” to the WLAN 200, the UE 10 must indicate a user name NAI as identity in the EAP signaling exchange. A realm part of this NAI is used to route the authentication request to a relevant Home Private Land Mobile Network (HPLMN) for the user. This realm part may be in the form of an Internet domain name, such as “operator.com”, as specified in IETF specification RFC 1035. When attempting to authenticate within WLAN access, the UE 10 can derive the home network domain name from the IMSI as provided in a USIM Integrated Circuit Card (UICC).

However, in case of a UICC-less UE, the UE 10 does not have access to a home realm, because it is information stored in the SIM. It is still desirable to allow connectivity at least for IMS (IP Multimedia Subsystem) emergency calls or other prioritized calls.

According to an exemplary embodiment of the present invention, a unique realm or unique field may be used as an example of a unique default identifier portion, which indicates to the WLAN 200 that this authentication is made for a prioritized call, such as an IMS emergency call. The AP 20 in the WLAN 200 recognizes a default realm as an IMS emergency call string, and forwards the corresponding response from the UE 10 to the AAA server 30, as a default AAA server, in a default PLMN. The AAA server 30 then applies a predetermined default EAP method, such as a new emergency call EAP method, to authenticate the UE 10.

An alternative authentication procedure may include a so called “null” method, which does not authenticate anything. As an alternative, the authentication procedure could be adapted to authenticate the AAA server 30 with a server certificate, if it can be assumed later that emergency service route public keys are available in the UE 10. Such authentication procedure can prevent an attacker from impersonating as an emergency call service provider. In accordance with an embodiment of the present invention, the dedicated authentication method, such as the EAP method, can be a one-round request/response exchange. The EAP master key may be either a fixed well-known key (known at least to plurality of clients), or it may be transmitted in the EAP method.

In general, any key could be used, which the authentication procedure or method “exports” outside, so that the keys can be transmitted to wireless LAN access points of IPsec gateways, for example. In RFC 3748, the exported session keys are called “master session key (MSK)” and “extended master session key (EMSK).” The session key can be transported from the authentication server to access points, IPsec gateways or other authenticators, in line with the EAP protocol specified in RFC 3748 as an example. This provides an advantage in which exported keys are provided even though there are no real authentication credentials.

The MSK relates to keying material derived between an EAP peer and server and exported by the EAP method. The MSK may be at least 64 octets in length. In existing implementations, an AAA server acting as an EAP server would transport the MSK to the authenticator. The EMSK relates to additional keying material derived between an EAP client and server that are exported by the EAP method. The EMSK may be at least 64 octets in length. In one embodiment, the EMSK may not be shared with the authenticator or any other third party. As an example, the AAA server 30 can send a random key to the authentication peer device in a corresponding authentication request packet, such as an EAP-Request/Emergency Call packet. This random key is required to keep the authentication method technically similar to actual authentication methods.

According to another example, the dedicated authentication method may be adapted to use an existing tunnel method, such as a Protected EAP (PEAP) method for authentication. In such a tunnel based method, an inner method is encapsulated within a tunnel method. Specifically, packets of the inner authentication method are encapsulated by packets of the tunnel method. As an example, the inner method may be a null method, as described above. In this case, the tunnel method would derive a key as usual. Because the inner method would not need to derive a key in this case, the inner method would also be an existing authentication method, such as EAP Generic Token Card with a known user name and password. In the Generic Token Card mechanism, the authentication request contains a displayable message, and a response contains a string read from the hardware token card. The above described specific EAP methods can be used for Scenario 2 and Scenario 3 authentication, as defined in the above described I-WLAN specifications.

In accordance with an embodiment of the present invention, FIG. 2 illustrates a specific implementation of an UICC-less emergency call in a I-WLAN environment. Specifically, FIG. 2 shows a schematic signaling and processing diagram indicating the network elements, as illustrated in FIG. 1, and corresponding messages exchange between these elements, in accordance with an embodiment of the present invention.

In operation 1, the AP 20 of the WLAN 200 sends an EAP ID request to the UE 10, as usual. In response thereto, the UE 10 wishing to make an emergency call generates a NAI with a specific field or realm “ECALL” indicative of a priority or an emergency call. The NAI may be represented in a form of a domain name to read “IMEI@ECALL,” for instance, where an International Mobile Equipment Identity (IMEI) may be derived at the UE 10 without requiring the UICC. At operation 2, the obtained NAI would be incorporated into the EAP ID response and transmitted to the AP 20. Here the AP 20 in the WLAN 200 would read and recognize therefrom that this specific service-specific NAI as an emergency call. At operation 3, the AP 20 forwards the EAP ID response to a predetermined default AAA server, for instance, the AAA server 30, in a default PLMN. At operations 4 and 5, the AAA server 30 detects the service-specific unique realm and initiates a specific EAP method with at least one request round at operation 4 and a response round at operation 5 until the EAP exchange is completed successfully. At operation 6, the selected default EAP method may include an optional step x−1 where a policy information or policy enforcement is downloaded to the WAG 40, to restrict call related services, that is, to allow only emergency call services for the authenticated UE 10. At operations 7 and 8, a successful EAP is indicated to the UE 10 via the AP 20 by corresponding EAP Success messages forwarded in operation 7 (i.e., x) and operation 8 (i.e., x+1).

It is to be understood that in the embodiment of the present invention, the operations are performed in the sequence and manner as shown although the order and execution of the operations and the like may be changed without departing from the spirit and scope of the present invention.

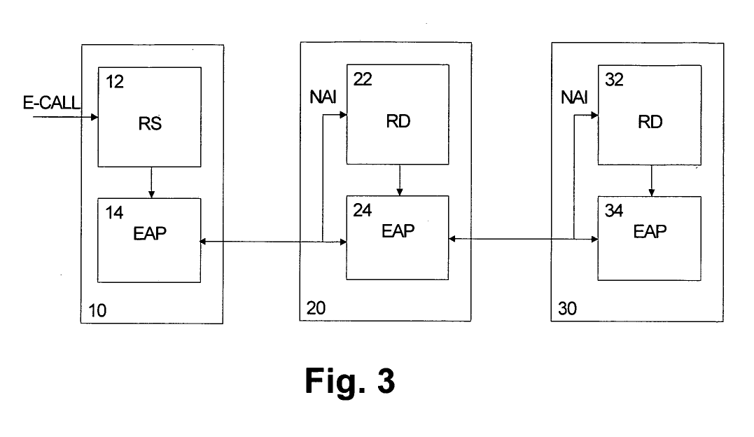

FIG. 3 shows a schematic block diagram indicating the network elements involved in the authentication process and specific units and functions thereof, in accordance with an embodiment of the present invention. When the emergency call is initiated by a user at the UE 10, a corresponding field or realm setting function (RS) unit 12 determines the default realm and generates a corresponding NAI forwarded to an EAP control unit 14 which generates the EAP ID response. This response is then forwarded to the AP 20 of the WLAN 200 where the NAI is extracted and supplied to a realm detection function (RD) unit 22 which detects the default realm and controls an EAP control unit 24 to select the predetermined AAA server 30 and forward the EAP ID response to the selected or determined AAA server 30.

At the default AAA server 30, the NAI is again extracted and detected at a realm detection (RD) unit 32. Based on the detection of the default realm part, the realm detection function or unit 32 controls an EAP control unit 34 to initiate a predetermined EAP method as described above.

A person of ordinary skill in the art will appreciate that several default realm parts may be used for different prioritized calls so as to route EAP ID requests to at least one AAA server and initiate more than one specific EAP method. Such prioritized calls may include a fire alarm call, an emergency doctor call, etc.

Accordingly, in accordance with the various embodiments of the present invention described above, access by a UICC-less UE is enabled in order to make an emergency call or other prioritized calls. One of the many benefits of this prioritized access method is that it is transparent to existing AAA elements, WLAN access points and packet data gateways. No new emergency call related functionality is required at these devices, if the existing policy enforcement mechanisms are sufficient for restricting the service to specific prioritized calls, such as emergency calls.

One of the many benefits of using a service-specific realm or other service-specific default identifier portion is that for UICC-less UEs or other terminal devices without inserted SIM or USIM card, an authentication negotiation can be started with a default network or PLMN. Then, a default authentication method can be used so that the impact on the WLAN access network can be reduced to a straight forward configuration of the realm in a corresponding routing table, for instance, RADIUS (Remote Address Dial-In User Service) routing tables. The default authentication method of the present invention provides an advantage in which no special keys or behavior is needed to be implemented in the WLAN 200.

As an additional advantage, the use of a single or unique service-specific default identifier portion ensures that the authentication method can be made transparent to existing authentication network elements, WLAN access points, packet data gateways, etc. Thus, no new emergency call related functionality is required in these network elements, as long as the existing policy enforcement mechanisms are sufficient for restricting the service to emergency calls only.

The unique default identifier portion may be a realm part or at least a portion of the realm part of a network access identifier. Thus, a realm specific to a prioritized call (e.g. an emergency call) is set for a UICC-less UE, and an EAP negotiation can easily be started with a default PLMN. Thereby, the impact on wireless access networks can be reduced to a straight forward configuration of a realm in the corresponding routing tables, in which the specific realm directly indicates a prioritized call (e.g. emergency call), thereby directly implying routing to a default PLMN without any special keys or behavior required to be implemented in the wireless access network. Such prioritized access scheme is especially advantageous in cases where a subscriber identity module (e.g. UICC) is not provided in the terminal device. Nevertheless, such prioritized access scheme can also be advantageous in cases where such a subscriber identity module is provided because the SIM/USIM based authentication and/or authorization procedures may be bypassed.

In addition, the default service-specific authentication method may be a null method which does not authenticate anything. As an alternative, the default service-specific authentication method may be adapted to use a one-way authentication in which the authentication server is authenticated by the terminal device. As an example, the default service-specific authentication method may be adapted to authenticate the authentication server with a server certificate.

In particular, the default service-specific authentication method may be a one-round request/response exchange. The default service-specific authentication method may be configured to use a fixed key known at least to a plurality of clients as an exported session key, or configured to derive the exported session key from at least one known fixed key. In an alternative, the default service-specific authentication method may be configured to use an exported session key or information required in derivation of the exported session key may be transferred in the default service-specific authentication method from the authentication server to the terminal device or vice versa.

Additionally, the default service-specific authentication method may use a tunnel method. Then, an inner method encapsulated in the tunnel method may be a null method. As an alternative, the inner method encapsulated in the tunnel method may be a generic method using a token card with known user name and password.

Furthermore, the authentication server may be configured to transmit policy information to an access gateway of the wireless access network, where the policy information may define at least one allowable service. The at least one allowable service may include an emergency call or an emergency service.

In general, the processing steps underlying the present invention may be implemented as concrete hardware entities or units, or alternatively may be based on software routines controlling data processors or computer devices provided in the terminal device or a smart card or similar device inserted thereto, the network element or the authentication server. Consequently, the present invention may be implemented as a computer program embodied on a computer readable medium, the computer program being configured to perform each individual operation described above for the authentication method.

It is to be noted that the above described prioritized access control scheme is by no means restricted to the above preferred embodiment and can be used in connection with any authentication procedure which is based on an identifier portion. In particular, any information which can serve as a service-specific unique default identifier portion dedicated to a predetermined prioritized call can be used instead of the above described realm part of the NAI. Moreover, any suitable service-specific authentication method can be used for authentication. The preferred embodiments may thus vary within the scope of the attached claims.

With respect to the present invention, the network elements or devices described above may be any device that utilizes network data, and can include switches, routers, bridges, gateways or servers. many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. A method of controlling prioritized access to a wireless access network, the method comprising:
setting an identifier portion of an authentication response to a service-specific unique default identifier portion, wherein the service-specific unique default identifier portion defines an activation of a call for a predetermined prioritized service at a terminal device;
receiving the authentication response at the wireless access network;
detecting the default identifier portion at the wireless access network;
forwarding the authentication response to a predetermined default authentication server in response to the detection of the default identifier portion at the wireless access network; and
initiating at the default authentication server a default service-specific authentication method for authorizing the terminal device to access the predetermined prioritized service.

2. A method according to claim 1, further comprising:
configuring the unique default identifier portion as a realm part or a portion of a realm part of a network access identifier.

3. A method according to claim 1, further comprising:
using the prioritized access when a subscriber identity module is not provided in the terminal device.

4. A method according to claim 1, wherein the predetermined prioritized service comprises an emergency service or an emergency call.

5. A method according to claim 1, further comprising:
excluding authentication by providing a null method as the default service-specific authentication method.

6. A method according to claim 1, further comprising:
performing a one-way authentication in which the authentication server is authenticated by the terminal device using the default service-specific authentication method to perform.

7. A method according to claim 6, further comprising:
authenticating the authentication server with a server certificate using the default service-specific authentication.

8. A method according to claim 1, further comprising:
performing a one-round request/response exchange using the default service-specific authentication method.

9. A method according to claim 1, further comprising:
configuring the default service-specific authentication method to perform one of using a fixed key known at least to a plurality of clients as an exported session key and deriving the exported session key from at least one known fixed key.

10. A method according to claim 1, further comprising:
transmitting an exported session key or information required in derivation of the exported session key in the default service-specific authentication method from the authentication server to the terminal device or vice versa.

11. A method according to claim 1, further comprising:
configuring the default service-specific authentication method to use a tunnel method.

12. A method according to claim 11, further comprising:
configuring an inner method encapsulated in the tunnel method as a null method.

13. A method according to claim 11, further comprising:
configuring an inner method encapsulated in the tunnel method as a generic method using a token card with known username and password.

14. A method according to claim 1, further comprising:
transmitting policy information from the authentication server to an access gateway of the wireless access network, the policy information defining at least one allowable service.

15. A method according to claim 14, wherein the at least one allowable service comprises an emergency call or an emergency service.

16. A terminal device for providing prioritized access to a wireless access network, the terminal device comprising:
setting means for setting an identifier portion of an authentication response to a service-specific unique default identifier portion, wherein the service-specific unique default identifier portion defines an activation for a predetermined prioritized service.

17. A terminal device according to claim 16, wherein the service-specific unique default identifier portion is a realm part of a network access identifier.

18. A terminal device according to claim 16, wherein the predetermined prioritized service is an emergency call.

19. A terminal device according to claim 16, wherein the setting means are configured to operate in an absence of a subscriber identity module.

20. A network element of a wireless access network for controlling prioritized access to the wireless access network, the network element comprising:
detecting means for detecting a predetermined unique default identifier portion in a received authentication response; and
forwarding means for transmitting the received authentication response to a predetermined default authentication server in response to the detection of the unique default identifier portion by the detecting means.

21. A network element according to claim 20, wherein the unique default identifier portion is a realm part of a network access identifier.

22. A network element according to claim 20, wherein the network element is an access point of a wireless local area network.

23. An authentication server for controlling prioritized access to a wireless access network, the authentication server comprising:
means for detecting a predetermined unique default identifier portion in a forwarded authentication response received from the wireless access network; and
initiating means for initiating a predetermined authentication method dedicated to the unique default identifier portion in response to the detection of the unique default identifier portion by the detecting means.

24. A authentication server according to claim 23, wherein the predetermined unique default identifier portion is a realm part of a network access identifier.

25. A authentication server according to claim 23, wherein the initiating means are configured to initiate as the predetermined authentication method a null method which excludes authentication.

26. A authentication server according to claim 23, wherein the initiating means are configured to initiate as the predetermined authentication method an authentication method arranged to authenticate the authentication server with a server certificate.

27. A authentication server according to claim 23, wherein the initiating means are configured to initiate a tunnel method as the predetermined authentication method.

28. A authentication server according to claim 23, wherein said authentication server is configured to transmit policy information to an access gateway of said wireless access network, said policy information defining at least one allowable service.

29. A computer program embodied on a computer readable medium, the computer program being configured to perform a control of prioritized access to a wireless access network, the computer program configured to perform:
setting an identifier portion of an authentication response to a service-specific unique default identifier portion, wherein the service-specific unique default identifier portion defines an activation of a call for a predetermined prioritized service at a terminal device.

30. A computer program embodied on a computer readable medium, the computer program being configured to perform a control of prioritized access to a wireless access network, the computer program configured to perform:
receiving an authentication response at the wireless access network;
detecting a default identifier portion of the authentication response at the wireless access network; and
forwarding the authentication response to a predetermined default authentication server in response to the detection of the default identifier portion at the wireless access network.

31. A smart card comprising a computer program, the computer program being configured to perform a control of prioritized access to a wireless access network, the computer program configured to perform:
setting an identifier portion of an authentication response to a service-specific unique default identifier portion, wherein the service-specific unique default identifier portion defines an activation of a call for a predetermined prioritized service at a terminal device.

32. A system for controlling prioritized access to a wireless access network, the system comprising:
a network element of a wireless access network comprising
detecting means for detecting a predetermined unique default identifier portion in a received authentication response, and
forwarding means for transmitting the received authentication response to a predetermined default authentication server in response to the detection of the unique default identifier portion by the detecting means; and
an authentication server comprising
means for detecting a predetermined unique default identifier portion in a forwarded authentication response received from the wireless access network, and
initiating means for initiating a predetermined authentication method dedicated to the unique default identifier portion in response to the detection of the unique default identifier portion by the detecting means.
